(19) United States
(12) Patent Application Publication
(10) Pub. No.: US 2006/0238455 A1
(43) Pub. Date: Oct. 26, 2006

(54) Display device

(75) Inventors: Dirk De Bruin, Eindhoven (NL); Pieter Engelaar, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/552,830

(22) PCT Filed: Apr. 14, 2004
(86) PCT No.: PCT/IB04/50434

§ 371 Date: Oct. 13, 2005

(30) Foreign Application Priority Data
Apr. 17, 2003 (EP) 03101055.6

(51) Int. Cl. G09G 3/22

(52) U.S. Cl. 345/75.2

(57) ABSTRACT

The present invention relates to a display device comprising a screen (1) with a plurality of pixels. Each pixel has a corresponding electron emitting structure (8, 9, 11), such as a gate-cathode combination. The electrons emitted by each electron emitting structure (8, 9, 11) are accelerated toward an anode layer (12) in the screen (1). The anode layer (12) is subdivided into a plurality of separate portions (12a, . . . 12l), and each such portion has a corresponding current meter (15a, . . . 15l) for measuring the portion's part of the total anode current of the display device. This entails an improved capability of measuring the properties of the individual electron emitting structures, which serves to adjust each electron emitting structure's signal in order to obtain a more uniform display device.

### TECHNICAL FIELD

The present invention relates to a display device, comprising a screen with a plurality of picture elements, a planar anode electrode, located in the screen, a plurality of electron emitting structures, each corresponding to a picture element, the electron emitting structures being arranged to emit electrons intended to be accelerated towards the anode, and means for measuring the anode current.

### TECHNICAL BACKGROUND

Such a display device is disclosed in EP 1225557, A1. The anode current measuring means allows the properties of each pixel's corresponding electron emitting element, e.g. its voltage-current characteristics, to be measured during so-called blanking periods, when the pixels are not otherwise activated. With information regarding the properties of each pixel's electron source at hand, the signals controlling these sources may be adjusted in order to obtain a more uniform display device, i.e. so that, for a given input signal, all pixels emit light with the same strength.

A problem with such a display device is that the properties for each pixel may only be updated at a low rate, since measurements can only take place during blanking periods and only for one pixel at a time. This means that pixel property information will not always be up to date, since the properties may change, e.g. with changing operating temperature. Moreover, measuring pixel properties during blanking periods may cause visible disturbances in the display device, since a light signal is produced which does not belong to the received image signal.

### SUMMARY OF THE INVENTION

An object of the present invention is to wholly or partially obviate the above problems.

This object is achieved with a display device of the above indicated type, wherein the anode electrode is divided into a plurality of electrically separate planar anode portions, wherein each anode portion comprises current measuring means for measuring a portion of a total anode current. This means that pixel properties may be measured for more than one pixel at the same time, thus allowing the pixel properties to be updated more often.

In a preferred embodiment the picture elements are arranged to be activated in groups, and the anode portions are arranged in such a way that picture elements, which belong to a given group, correspond to different anode portions. This allows the pixel properties to be measured during normal displaying, updating all pixels' properties in all display frames and without causing any visual disturbances.

Preferably the picture elements are arranged in lines and columns, the display device being arranged to activate a line at a time, and each column having a corresponding anode portion in the form of a strip. This entails the possibility to update pixel properties during a normal video display process.

Preferably, the display device comprises a memory for storing, for each picture element, information relating to the properties of its corresponding electron emitting structure, which information is based upon an anode current measured for that picture element.

Preferably, the display device is arranged to use information stored in this memory for adjusting drive signals for the electron emitting structures.

In a preferred embodiment, the display device comprises means for integrating current data measured by said current measuring means. This allows the pixel property information to include rise and fall periods in the current envelops.

Preferably, the display device comprises means for multiplexing current data, measured by said current measuring means. This allows a plurality of current meters to share a single level shifter, which is used to shift the current signal to the voltage level of the electron emitting structure. This provides for reduced complexity and costs.

Preferably, each current measuring means comprises a current mirror.

In a preferred embodiment, each electron emitting structure comprises a gate electrode and a cathode electrode.

In an alternative embodiment, each electron emitting structure comprises a light source and a portion of a photoelectric layer, the portion of the photoelectric layer being arranged to emit electrons when illuminated by the light source.

These and other aspects of the invention will be apparent from and elucidated with reference to the embodiments described hereinafter.

### BRIEF DESCRIPTION OF THE DRAWINGS

FIG. 1 illustrates schematically a display device according to known art.

FIG. 2 shows a controllable electron emitting structure, associated with a pixel in a display device.

FIG. 3 illustrates schematically a screen anode arrangement for a display device according to known art.

FIG. 4 illustrates schematically a screen anode arrangement for a display device according to a preferred embodiment of the invention.

FIG. 5 shows a control arrangement for a display device according to an embodiment of the invention.

FIG. 6 shows a control arrangement for a display device according to an alternative embodiment of the invention.

FIG. 7 shows a current mirror arrangement.

FIG. 8 illustrates schematically a level shifting arrangement.

### DESCRIPTION OF PREFERRED EMBODIMENTS

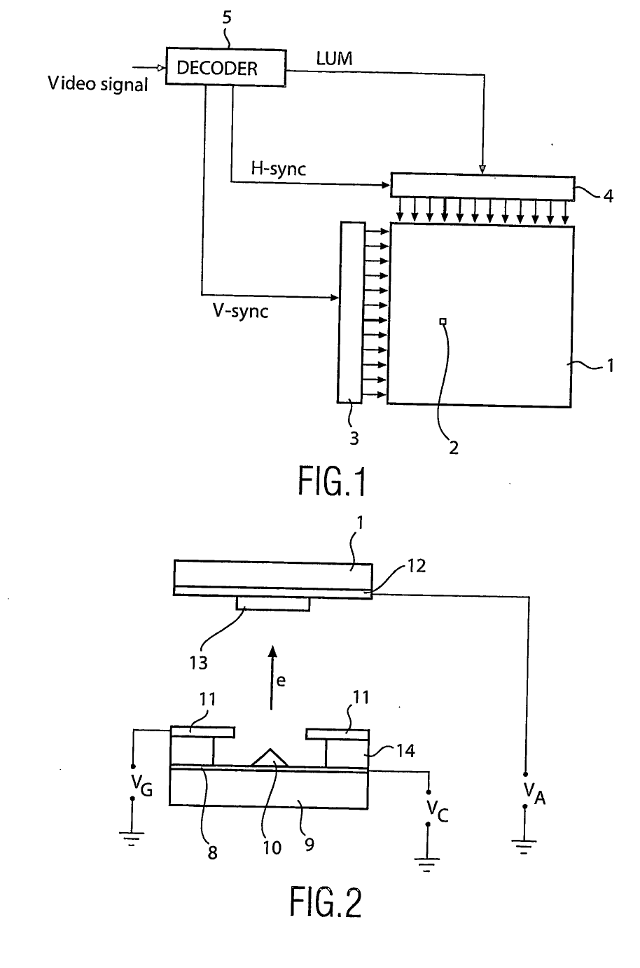

FIG. 1 illustrates schematically a display device according to known art. The display device comprises a screen 1, comprising a large number, e.g. in case of a wxga display 768×1365, of picture elements 2, which hereinafter are called pixels. The display device may be used for instance as a computer monitor or a TV. The luminance of the pixels in the screen are controlled by a line driver 3 and a column driver 4. By activating a specific line and a specific column (bold arrows), the drivers 3, 4 cause a specific pixel 2 in the line-column intersection to emit light. The display device receives a video signal, and a decoder 5 generates, from the video signal, horizontal and vertical synchronization signals (H-SYNC, V-SYNC) and a luminance signal (LUM), which are fed to the drivers 3, 4. By activating the pixels 2 of the screen 1 an image, corresponding to the received video signal, is thus generated. In the display device, each pixel has a corresponding controllable electron emitting structure. The figures are of course schematic e.g. in that they show only 12×12 pixels in order to facilitate comprehension of the invention. As mentioned above the number of pixels could be considerably greater.

FIG. 2 shows a controllable electron emitting structure, associated with a pixel in a display device. The structure comprises a cathode electrode 8 disposed on a glass substrate 9. On the cathode electrode 8 an emission material 10 is disposed, in contact with the cathode electrode 8.

A gate electrode 11 is provided, separated form the cathode by means of an insulating layer 14. The gate electrode 11 and the insulating layer 14 contain holes. At the position of these holes, the gate 11, the cathode 8 and the emission material 10 together constitute a controllable electron emitting structure. By applying a suitable difference between potential V_{C} of the cathode 8 and the potential of the gate V_{G} (e.g. V_{C}=−30 V and V_{G}=60 V) a local electric field is generated near the emission material 10, which causes the emission material 10 to emit electrons (e). (Note that the cathode itself may constitute an emission material in which case no additional layer need be applied.) The electrons emitted by the controllable electron emission structure are accelerated towards an anode 12 in the screen, which anode 12 has a significant positive potential (e.g. V_{A}=5 kV). When electrons reach the screen, they hit a phosphorescent layer 13, which as a consequence emits light. A gate electrode 11 may preferably be strip-shaped and common to all pixels in a line, and is then controlled by a line driver 3. A cathode may preferably be strip-shaped and common to all pixels in a column, and is then controlled by a column driver 4.

The present invention is also applicable to so-called photo cathode displays. Then, each electron emitting structure comprises a light source and a portion of a photoelectric layer, the portion of the photoelectric layer being arranged to emit electrons when illuminated by the light source.

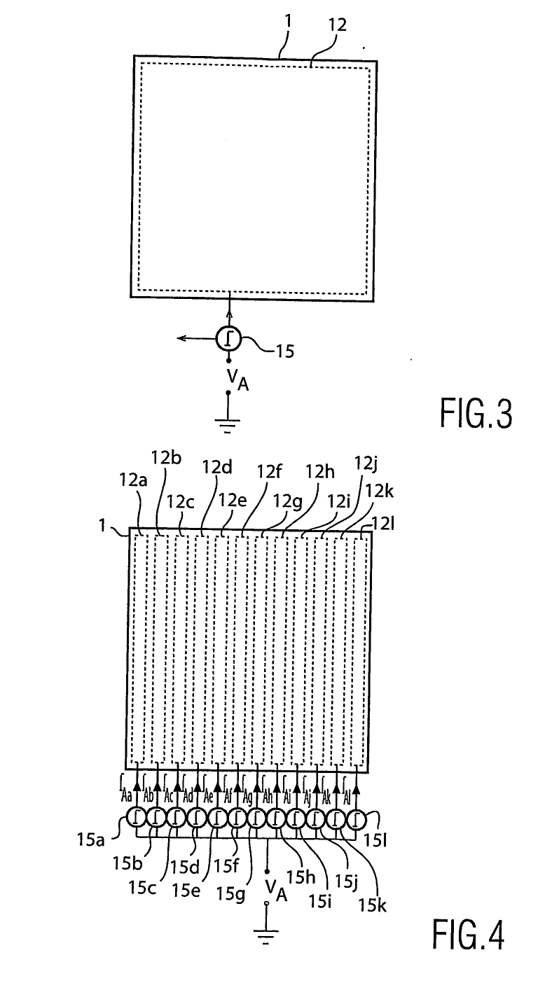

FIG. 3 illustrates schematically a screen anode arrangement for a display device according to known art. The screen 1 comprises a continuous conductive anode layer 12 which is common to all pixels in the display device. The anode layer is connected to a voltage source to provide the anode voltage V_{A}. The arrangement further comprises current meter 15 for measuring the anode current I_{A}.

When a large number of electron emitting structures of the type shown in FIG. 2 are produced in a manufacturing process, the emissive properties of the individual structures will vary over the display. That is, for a given gate-cathode voltage (in case of an amplitude modulated gate) or a given pulse ratio (in case of a pulse-width modulated cathode) individual emitting structures will emit different amounts of electrons. This leads to a non-uniform display. Moreover, the properties of the individual pixels may change also over time, e.g. due to changing ambient temperature or aging.

By activating only one pixel and measuring the resulting anode current, properties of the electron emitting structure corresponding to this pixel may be determined and stored in a memory. When the display is used, this information may then be used to adjust the gate or cathode voltage (or pulse ratio) for individual electron emitting structures in order to achieve a uniform display.

This measuring takes place in blanking periods when pixels otherwise are not normally activated. Since the number of pixels is large, the properties information for each pixels electron emitting structure can be updated only very seldom and is therefore not always up to date, e.g. when the operating temperature changes.

FIG. 4 illustrates schematically a screen anode arrangement for a display device according to a preferred embodiment of the invention. According to the preferred embodiment, the anode layer is structured, so as to form a plurality of electrically separated anode layer portions 12a, 12b, 12c, 12d, etc. Each such portion preferably corresponds to a column in the display device. Each portion may comprise an indium tin oxide layer. A current sensor 15a, 15b, 15c, 15d, etc. is arranged for each of the anode layer portions.

Different processes may be used for providing the separated anode layer portions. The layer may be provided as separate portions from the start, e.g. by a printing process. As an alternative, a continuous layer may be provided, which is subsequently separated into a plurality of portions in an etching process.

Since the pixels normally are activated a line at a time, the anode currents corresponding to each of the pixels in each line may be measured individually during regular displaying. This allows the pixel property information to be updated each time the pixel is activated.

Note that already by dividing the anode layer in two portions, pixel property information may be updated twice as often as compared with a continuous anode layer, since twice as many pixels can be updated during each blanking period.

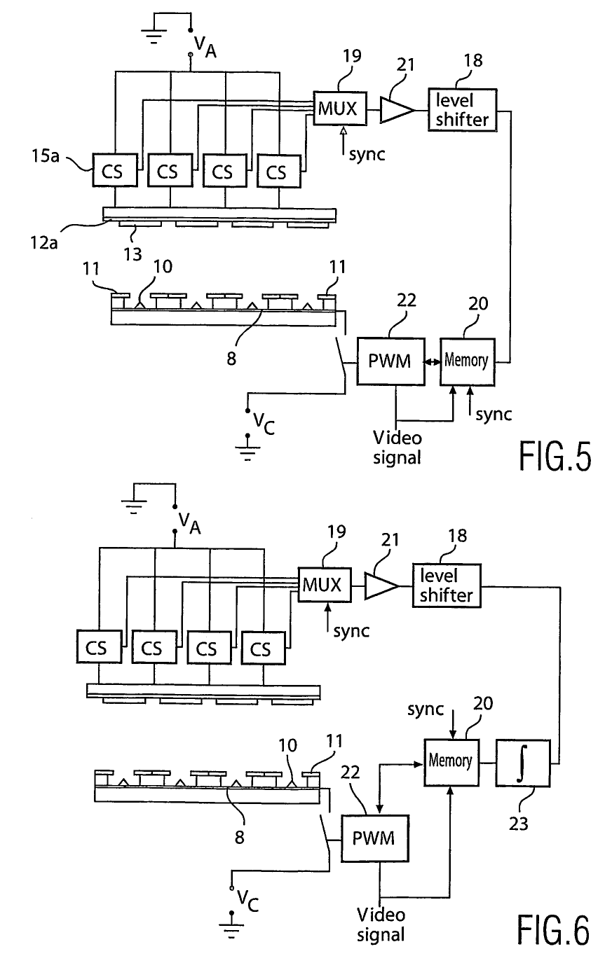

FIG. 5 shows a control arrangement for a display device according to an embodiment of the invention. The current sensor outputs are generated at the high anode potential, which means that a level shifter 18 is needed to bring the signal down to the cathode voltage potential. In principle, each current sensor may have its own level shifter, but in order to reduce the complexity and costs a multiplexing arrangement may be used as illustrated in FIG. 5. In this case four current sensors 15a, 15b, etc share a common level shifter 18, and are connected to the level shifter via a multiplexer 19. The multiplexer receives synchronizing information in order to determine which of the inputted signals should be passed on to a memory 20 via the level shifter 18 and an amplifier 21. The memory 20 receives corresponding synchronizing information to be able to store the information correctly, i.e. as belonging to a particular pixel. As will be described later, the current signal value, or another value, calculated based on the current signal value is stored in the memory 20. This value is used by a pulse width (PWM) modulator 22 to control the pulse ratio of the cathode voltage.

By using a multiplexer the complexity and the costs of the circuit may thus be reduced. Of course, when for instance four current sensors share a common level shifter, the property information of each pixel may be updated with a four times lower frequency, but in many applications this is allowed. The number of level shifters may therefore be varied between one and one for each anode layer portion, depending on the application requirements.

The information stored for each pixel in the memory relates to a property value or information that may be used to calculate such a value. E.g. in case of pulse-width modulation the actual measured anode current Iₘₑₐₛ may be stored. The cathode pulse ratio Tₚᵤₗₛₑ for that pixel may then be calculated as Tₚᵤₗₛₑ=T_{d}*Iₘₑₐₛ/I_{d}, where T_{d} is the ideal pixel pulse ratio for the desired grey scale level and I_{d} is the ideal anode current in the high state of the pulse cycle, which current is the same for all pixels. For cases with amplitude modulation, information regarding the emitter signal should be stored together with the measured anode current that is its result, as is recognized by the skilled person.

FIG. 6 shows a control arrangement for a display device according to a preferred alternative embodiment of the invention. Compared with the embodiment in FIG. 5, an integrator 23 is added in this arrangement. The integrator serves to make the current signal from each sensor more representative of the electron flow actually received in a pixel. If for instance PWM-modulation is used, the electron flow varies greatly during the activation of a pixel, even if the resulting light emission is relatively constant. Thus, if the current sensor is sampled at an arbitrarily chosen instant during the activation of a pixel, the resulting current value need not necessarily be representative of the electron flow actually received at the pixel. The integrator solves this problem by providing an output that is representative of the total anode current during the activation of a pixel. In this case, information regarding the pulse ratio should be stored together with the resulting anode current in order to obtain a description of properties of the individual emitter element.

In principle, the concept of integrating current measuring may be used also at the side of the electron emitting structures. If each cathode current is measured and integrated, the resulting value may be used, together with the cathode voltage or pulse ratio from which it results, to obtain in a similar way information about the pixel properties. By providing a current meter at the cathode electrodes and an integrator for integrating the current obtained for a given cathode voltage or pulse ratio, a property value for the pixel may be obtained, which value may be used to adjust the gate voltage or pulse ratio in order to obtain a more uniform display. This feature may thus be used also in display devices not employing divided anodes or anode current sensors.

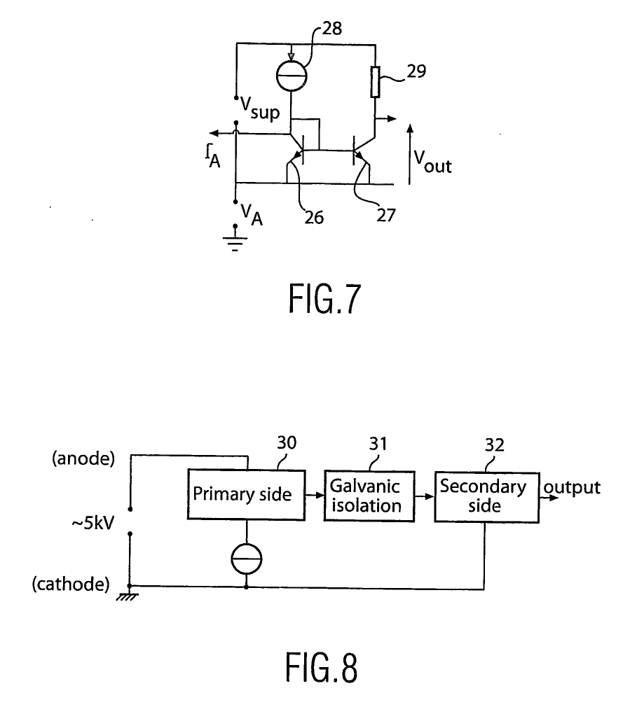

FIG. 7 shows a current mirror arrangement that may be used as a current measuring means. The current mirror comprises first and second transistors 26, 27 with interconnected bases, wherein the first transistor 26 is diode-coupled. The anode current I_{A} is drawn from a current source 28 at a supply voltage Vₛᵤₚ and, due to the current mirror arrangement, the current through a resistor 29 (with resistance R), connected to the second transistor, will be identical with I_{A}. Thus, the voltage Vₒᵤₜ will be equal to Vₛᵤₚ−I_{A}*R. The output voltage from the current mirror is thus representative of the anode current. If instead a current output is desired, the resistor may be omitted (R=0).

Other current measuring means are conceivable such as an operational amplifier in an current to voltage configuration. In general, it is important that the input impedance of the current measuring means matches with the impedance of the corresponding anode structure.

FIG. 8 illustrates schematically a level shifting arrangement. The arrangement comprises a primary side part 30, a galvanic isolation part 21 and a secondary side part 32. The primary side part 30 at a high potential of e.g. 5 kV comprises the current measuring means, generating the anode current signal and preferably converting it into an AC-signal to be transferred to the secondary side part 32, at the emitter level (at or close to ground level). The secondary side part 32 receives the transmitted signal and converts it into a format that may be used by control blocks at the emitter level. These parts are separated by the galvanic isolation part 31, comprising e.g. an isolating amplifier. The isolation part 31 should withstand the high DC voltage and at the same time be transparent to the measuring signal. Different types of capacitor/transformer combinations, optic components, such as photodiodes, and other components may be utilized to this end, as is well known to the skilled person.

In summary, the present invention relates to a display device comprising a screen with a plurality of pixels. Each pixel has a corresponding electron emitting structure, such as a gate-cathode combination. The electrons emitted by each electron emitting structure are accelerated toward an anode layer in the screen. The anode layer is subdivided into a plurality of separate portions, and each such portion has a corresponding current meter for measuring the portion's part of the total anode current of the display device. This entails an improved capability of measuring the properties of the individual electron emitting structures, which serves to adjust each electron emitting structure's signal in order to obtain a more uniform display device.

While the invention has been described in connection with various preferred embodiments, it should be understood that the invention should not be construed as being limited to those embodiments. The invention rather includes all variations which could be made thereto by a skilled person and within the scope of the appended claims. E.g. instead of pulse width modulation, as described in the above embodiment, amplitude modulation of cathode voltage may be used or a combination of pulse width modulation and amplitude modulation.

Instead of associating gate electrodes with rows and cathode electrodes with columns as described above, cathode electrodes may be associated with rows and gate electrodes with columns.

The invention is moreover also applicable to so-called under-gate emitters, wherein the gate electrodes are placed beneath the cathode electrodes as seen from the anode. Also other gate structures are possible, such as for instance side-gate emitters.

1. A display device, comprising a screen (1) with a plurality of picture elements (8, 10, 11), a planar anode electrode (12), located in the screen, a plurality of electron emitting structures (8, 10, 11), each corresponding to a picture element, the electron emitting structures (8, 10, 11) being arranged to emit electrons intended to be accelerated towards the anode (12), and means for measuring the anode current, characterized in that the anode electrode is divided into a plurality of electrically separate planar anode portions (12a, 12b, . . . , 12l), wherein each anode portion comprises current measuring means (15a, 15b, . . . , 15l) for measuring a portion of a total anode current.

2. A display device according to claim 1, wherein the picture elements are arranged to be activated in groups, and wherein the anode portions are arranged in such a way that picture elements, which belong to a given group, correspond to different anode portions.

3. A display device according to claim 2, wherein the picture elements are arranged in lines and columns, the display device being arranged to activate a line of picture elements at a time, and wherein each column has a corresponding anode portion substantially in the form of a strip.

4. A display device according to claim 1, comprising a memory (20) for storing for each picture element information relating to the properties of the corresponding electron emitting structures, which information is dependent on an anode current measured for that picture element.

5. A display device according to claim 4, wherein the display device is arranged to use information stored in the memory (20) for adjusting drive signals for the electron emitting structures.

6. A display device according to claim 1, comprising means (23) for integrating current data measured by said current measuring means.

7. A display device according to claim 1, comprising means (19) for multiplexing current data, measured by said current measuring means.

8. A display device according to claim 1, wherein each current measuring means comprises a current mirror.

9. A display device according to claim 1, wherein each electron emitting structure (8, 10, 11) comprises a gate electrode (11) and a cathode electrode (8).

10. A display device according to claim 1, wherein each electron emitting structure comprises a light source and a portion of a photoelectric layer, the portion of the photoelectric layer being arranged to emit electrons when illuminated by the light source.
